(19) United States
(12) Patent Application Publication
(10) Pub. No.: US 2015/0295303 A1
(43) Pub. Date: Oct. 15, 2015

(54) ELECTRONIC DEVICE HAVING ANTENNA STRUCTURE

(71) Applicants: Li-Chun Lee, Taipei City (TW); Chieh-Tsao Hwang, Taipei City (TW); Shih-Chia Liu, Taipei City (TW); Yen-Hao Yu, Taipei City (TW); Jhin-Ciang Chen, Taipei City (TW)

(72) Inventors: Li-Chun Lee, Taipei City (TW); Chieh-Tsao Hwang, Taipei City (TW); Shih-Chia Liu, Taipei City (TW); Yen-Hao Yu, Taipei City (TW); Jhin-Ciang Chen, Taipei City (TW)

(73) Assignee: COMPAL ELECTRONICS, INC., Taipei City (TW)

(21) Appl. No.: 14/557,453

(22) Filed: Dec. 2, 2014

Related U.S. Application Data
(60) Provisional application No. 61/979,505, filed on Apr. 14, 2014.

(51) Int. Cl. H01Q 1/22; H01Q 21/00; H01Q 13/10

(52) U.S. Cl. CPC H01Q 1/2266; H01Q 13/10; H01Q 21/0006

(57) ABSTRACT

An electronic device having antenna structure is provided. The electronic device includes a first body, a pivot assembly, a second body and an antenna structure. The pivot assembly is pivoted to the first body along a first axis. The second body is pivoted to the pivot assembly along a second axis. The antenna structure is disposed in the pivot assembly and has a first radiation portion, a second radiation portion and a third radiation portion. The first radiation portion and the second radiation portion have a slot therebetween to form a slot antenna. The third radiation portion forms a monopole antenna and is aligned to the slot. The third radiation portion and the slot are not coplanar.

### CROSS-REFERENCE TO RELATED APPLICATION

This application claims the priority benefits of U.S. provisional application Ser. No. 61/979,505, filed on Apr. 14, 2014. The entirety of the above-mentioned patent application is hereby incorporated by reference herein and made a part of this specification.

### BACKGROUND OF THE INVENTION

1. Field of the Invention

The invention relates to an electronic device, and more particularly, to an electronic device having an antenna structure.

2. Description of Related Art

Following the advancement of technology, current mass communication means have gradually been changed to wireless communication; devices such as smart phone, tablet PC with wireless Internet access, notebook computer and so forth are all fall within the scope of wireless communication; and in general, the wireless communication requires the use of an antenna to transmit messages.

In recent year, due to a means of intuitive touch operation and entertainment provided by the tablet PC, consumer market of the portable computer is divided by different functionalities between the tablet PC and the notebook computer divide. In order to satisfy consumer demand for commerce and entertainment, transformable notebook computer combining the notebook computer and the tablet PC gradually becomes one of the products favored by the consumer, screen of the transformable notebook computer may actuate to various positions in relative to the host for transforming into a variety of operating states. As such, an antenna is generally disposed within a casing of the screen, so that when the screen actuates in a manner, as described in the above, to change relative positions of the antenna and the metal casing of the host, the metal casing may shield the antenna and influence the signal transceving ability of the antenna.

### SUMMARY OF THE INVENTION

The invention is directed to an electronic device, whereby an antenna structure thereof has stable signal transceving ability.

The electronic device having the antenna structure of the invention includes a first body, a pivot assembly, a second body, and the antenna structure. The pivot assembly is pivoted to the first body along a first axis. The second body is pivoted to the pivot assembly along a second axis. The antenna structure is disposed in the pivot assembly and has a first radiation portion, a second radiation portion and a third radiation portion. The first radiation portion and the second radiation portion have a slot therebetween to form a slot antenna. The third radiation portion forms a monopole antenna and is aligned to the slot. The third radiation portion and the slot are not coplanar.

In one embodiment of the invention, the second body is opened from or closed to the first body through a relative pivoting between the first body and the pivot assembly along the first axis.

In one embodiment of the invention, the first axis is perpendicular to the second axis.

In one embodiment of the invention, the pivot assembly has a metal shaft, the antenna structure has a grounding portion, and the grounding portion is connected to the metal shaft.

In one embodiment of the invention, a length of the slot is equal to one-fourth or one-half of a wavelength of a first signal, a length of the third radiation portion equals to one-fourth of a wavelength of a second signal.

In one embodiment of the invention, a frequency of the second signal is greater than a frequency of the first signal.

In one embodiment of the invention, the antenna structure has a connecting section, the connecting section is connected with the first radiation portion and located in the slot, the third radiation portion includes a first section and a second section that are bent with each other, and the first section is connected between the connecting section and the second section.

In one embodiment of the invention, the electronic device further includes a cable, wherein the cable includes a signal line and a ground line, the connecting section has a feed point, the second radiation portion has a ground point, the signal line is connected to the feed point, and the ground line is connected to the ground point.

In one embodiment of the invention, the pivot assembly has a plastic casing, and the antenna structure is disposed on the plastic casing.

In one embodiment of the invention, the pivot assembly has a metal casing, and the antenna structure is disposed on the metal casing.

In one embodiment of the invention, the pivot assembly has a plastic member, and the plastic member is engaged in the metal casing and aligned to the slot.

In one embodiment of the invention, the second radiation portion has a folded wall.

In one embodiment of the invention, the slot has an open end, the antenna structure has a feed point in the slot, and a width of the slot gradually increases from the feed point towards the open end.

In one embodiment of the invention, the slot is a closed slot.

In view of the above, in the electronic device of the invention, the antenna structure, instead of being disposed in the second body, is disposed in the pivot assembly; and therefore, when the second body actuates in relative to the first body, relative positions of the antenna structure and the first body do not change substantially following a movement of the second body, so that the antenna structure is prevented from being shielded by a metal casing of the first body, thus providing the antenna structure with stable signal transceving ability. In addition, the antenna structure of the invention forms the slot antenna with the slot between the first radiation portion and the second radiation portion, and forms the monopole antenna with the third radiation portion, so as to cover a larger antenna operating frequency band with the coordination between the slot antenna and the monopole antenna. Moreover, in the invention, since the third radiation portion and the slot are not coplanar, the slot antenna and the monopole antenna do not interfere with each other and both have favorable signal transceving ability.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective diagram illustrating an electronic device according to an embodiment of the invention.

FIG. 2 and FIG. 3 illustrate a second body of FIG. 1 actuating in relative to a first body.

FIG. 4 is perspective diagram illustrating partial structure of the electronic device shown in FIG. 1 at the location of an antenna structure.

FIG. 5 is a perspective diagram illustrating the partial structure of the electronic device shown in FIG. 4 from another point of view.

FIG. 6 is a partial enlarged diagram of the electronic device shown in FIG. 5.

FIG. 7 a schematic diagram illustrating characteristics of S-parameters of the antenna structure shown in FIG. 1.

FIG. 8 is perspective diagram illustrating partial structure of an electronic device at the location of an antenna structure according to another embodiment of the invention.

FIG. 9 is perspective diagram illustrating partial structure of an electronic device at the location of an antenna structure according to another embodiment of the invention.

FIG. 10 is perspective diagram illustrating partial structure of an electronic device at the location of an antenna structure according to another embodiment of the invention.

FIG. 11 is perspective diagram illustrating partial structure of an electronic device at the location of an antenna structure according to another embodiment of the invention.

### DESCRIPTION OF THE EMBODIMENTS

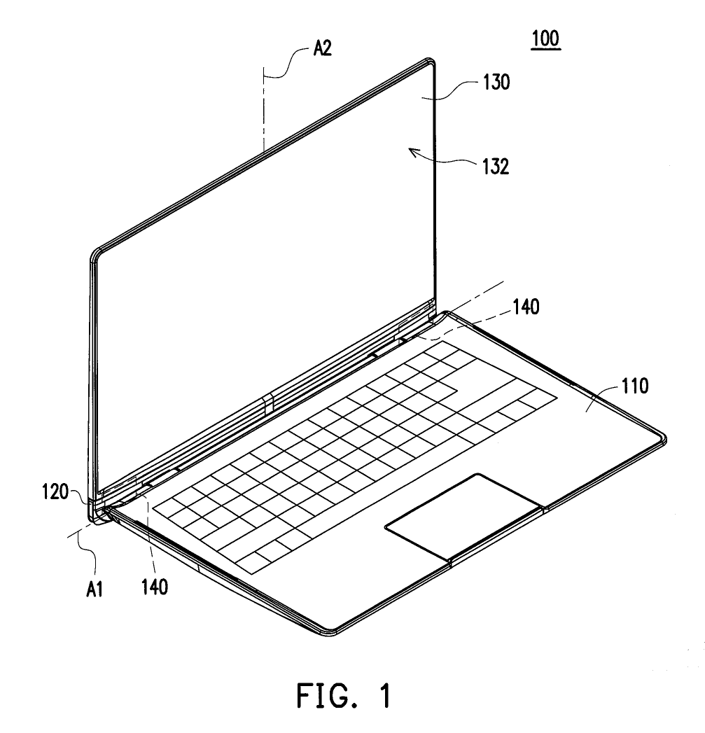

FIG. 1 is a perspective diagram illustrating an electronic device according to an embodiment of the invention. Referring to FIG. 1, an electronic device 100 of the present embodiment includes a first body 110, a pivot assembly 120, a second body 130, and at least one antenna structure 140 (illustrated as two). The first body 110, for example, is a host of the electronic device 100, and the pivot assembly 120 is pivoted to the first body 110 along a first axis A1. The second body 120, for example, is a screen of the electronic device 100, and is pivoted to the pivot assembly 120 along a second axis A2, wherein the first axis A1, for example, is perpendicular to the second axis A2. The antenna structure 140 is disposed within the pivot assembly 120.

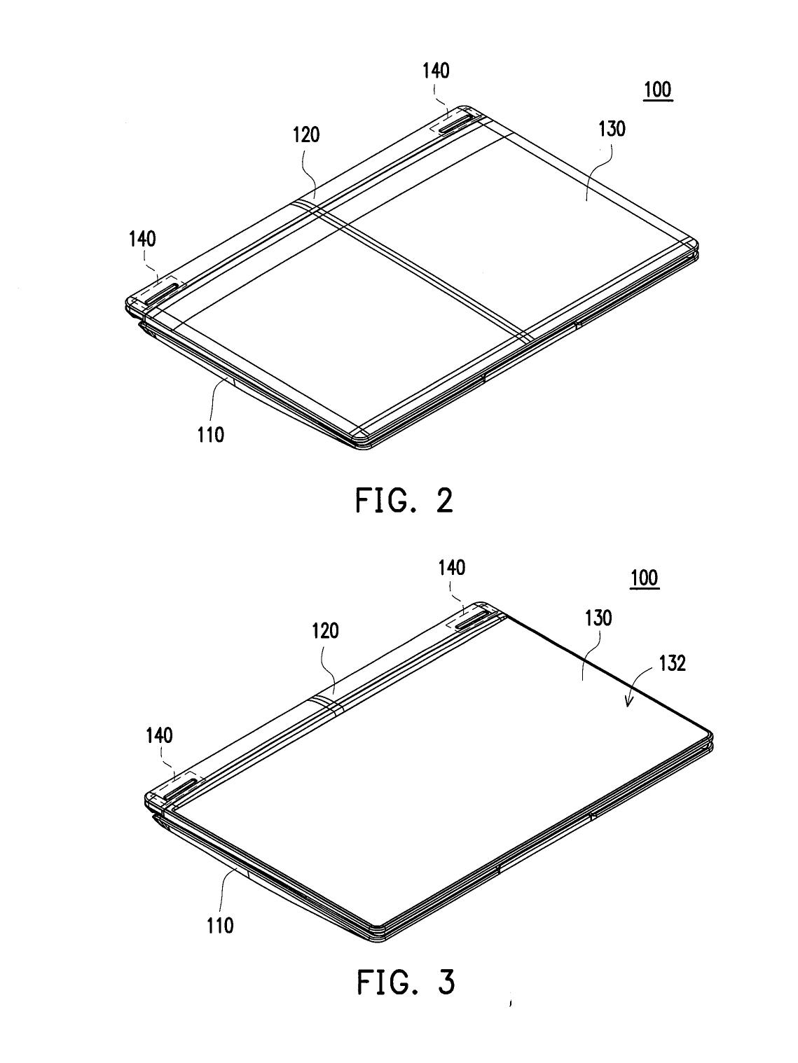

FIG. 2 and FIG. 3 illustrate a second body of FIG. 1 actuating in relative to a first body. The second body 130 may be closed to the first body 110, as shown in FIG. 2, or opened from the first body, as shown in FIG. 1, through a relative pivoting between the first body 110 and the pivot assembly 120 along the first axis A1, which being an operation mode of a notebook computer. In addition, through a relative pivoting between the second body 130 and the pivot assembly 120 along the second axis A2, when the second body 130 is closed to the first body 110, as shown in FIG. 3, a display surface 132 of the second body 130 is located an external side of the electronic device 100, which being an operation mode of a tablet PC.

Since the antenna structure 140, instead of being disposed in the second body 130, is disposed in the pivot assembly 120, when the second body 130 actuates in relative to the first body 110, as shown in FIG. 1 to FIG. 3, relative positions of the antenna structure 140 and the first body 110 do not change substantially following the movement of the second body 130, so that the antenna structure 140 is prevented from being shielded by a metal casing of the first body 110, thus providing the antenna structure 140 with stable signal transceving ability.

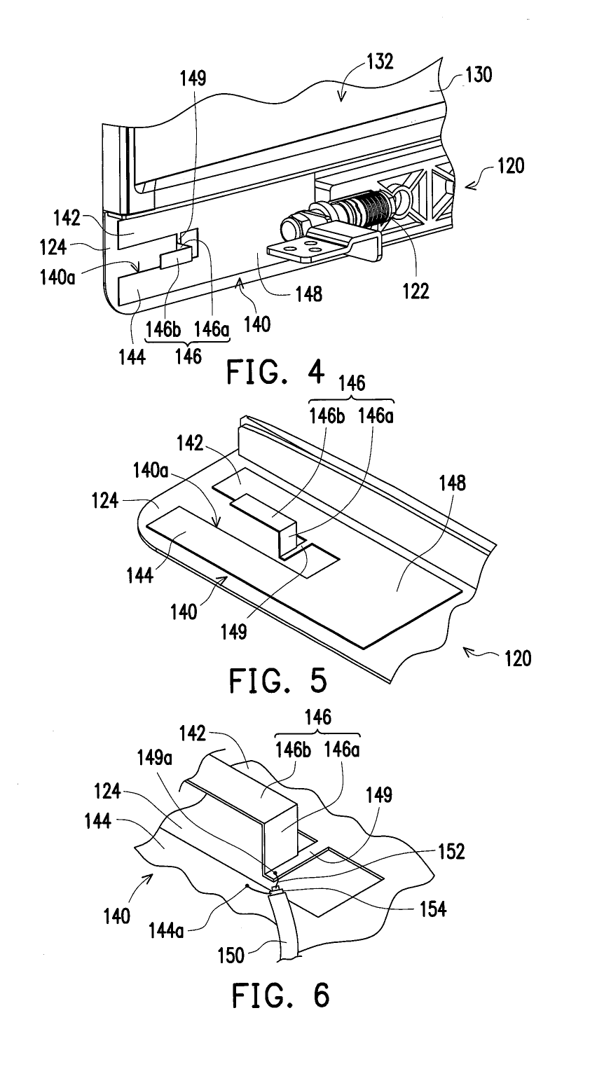

FIG. 4 is perspective diagram illustrating partial structure of the electronic device shown in FIG. 1 at the location of an antenna structure. FIG. 5 is a perspective diagram illustrating the partial structure of the electronic device shown in FIG. 4 from another point of view. Referring to FIG. 4 and FIG. 5, the antenna structure 140 of the present embodiment has a first radiation portion 142, a second radiation portion 144, a third radiation portion 146, and a grounding portion 148. The first radiation portion 142 and the second radiation portion 144 have a slot 140a therebetween to form a slot antenna. The third radiation portion 146 forms a monopole antenna and is aligned to the slot 140a. The pivot assembly 120 has a metal shaft 122 and pivots in relative to the first body 110 via the metal shaft 122, and the grounding portion 148 is connected to the metal shaft 122 so as to be grounded, wherein the metal shaft 122, for example, is connected to the metal casing of the first body 110, such that the metal shaft 122 and the metal casing of the first body 110 forms a grounding surface.

In the present embodiment, the slot 140a, for example, is a open slot and a length thereof, for example, equals to one-fourth of a wavelength of a first signal, a length of the third radiation portion 146, for example, equals one-fourth of a wavelength of a second signal, and a frequency of the second signal, for example, is greater than a frequency of the first signal. For instance, a frequency band of the first signal is approximately 2.4 GHz, whereby a frequency band of the second signal is approximately 5 GHz. With the coordination between the slot antenna and the monopole antenna, the antenna structure 140 may cover a larger antenna operating frequency band.

As shown in FIG. 5, the antenna structure 140 of the present embodiment has a connecting section 149, and the connecting section 149 is connected with the first radiation portion 142 and located in the slot 140a. The third radiation portion 146 includes a first section 146a and a second section 146b that are bent with each other, and the first section 146a is connected between the connecting section 149 and the second section 146b. With such configuration, the third radiation portion 146 and the slot 140a may be non-coplanar with each other, and thus the slot antenna and the monopole antenna do not interfere with each other and may both have favorable signal transceving ability.

FIG. 6 is a partial enlarged diagram of the electronic device shown in FIG. 5. Referring to FIG. 6, the electronic device 100 (as depicted in FIG. 1 to FIG. 3) further includes a cable 150, and the cable 150 includes a signal line 152 and a ground line 154. The connecting section 149 has a feed point 149a, the second radiation portion 144 has a ground point 144a, the signal line 152 is connected to the feed point 149a, and the ground line 154 is connected to the ground point 144a, so that the antenna structure 140 may feed the signals via the cable 150.

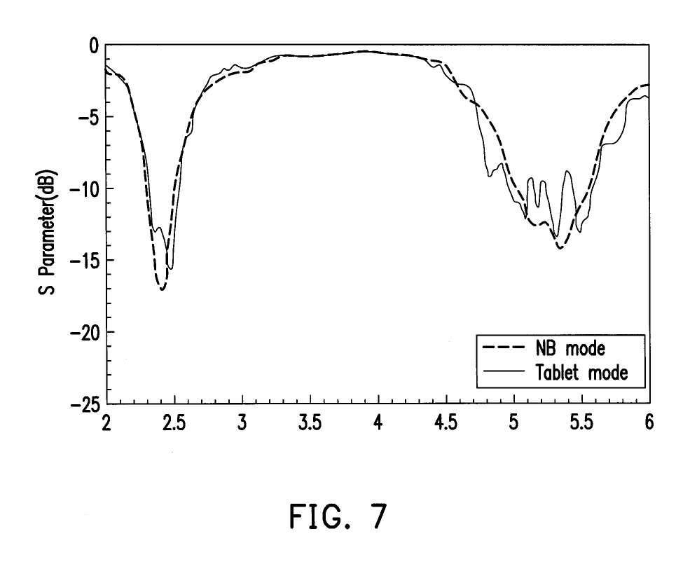

FIG. 7 a schematic diagram illustrating characteristics of S-parameters of the antenna structure shown in FIG. 1, wherein a NB mode in the figure represents the operation mode of the notebook computer shown in FIG. 1, and a Tablet mode in the figure represent the operation mode of the tablet PC shown in FIG. 3. As shown in FIG. 7, for the antenna structure configured by the above approach, S-parameters thereof are lower than −10 dB operational frequency bands of 2.4 GHz and 5 GHz, and thus the antenna structure has favorable characteristic performance. In addition, a table below shows radiation efficiencies of the antenna structure of FIG. 1 at different operational frequency bands, whereby the NB mode in the table represents the operation mode of the notebook computer shown in FIG. 1, and the Tablet mode in the table represents the operation mode of the table PC shown in FIG. 3. As shown in the table below, for the antenna structure configured by the above approach, qualified radiation efficiencies thereof the operational frequency bands of 2.4 GHz and 5 GHz are higher than 40% of the operation requirement.

| | Frequency (GHz) | | | | | |
|---|---|---|---|---|---|---|
| | 2.40 | 2.45 | 2.50 | 5.15 | 5.50 | 5.85 |
| NB mode | 77.25% | 72.14% | 71.13% | 68.32% | 67.28% | 41.47% |
| Tablet mode | 72.77% | 77.33% | 75.38% | 63.91% | 67.60% | 54.52% |

Referring to FIG. 4 and FIG. 5, the pivot assembly 120 of the present embodiment has a plastic casing 124, and the antenna structure 140 is disposed on the plastic casing 124. Nevertheless, the invention does not intend to limit the material of the casing of the pivot assembly 120; and an example thereof, accompanied by a drawing, is described in below.

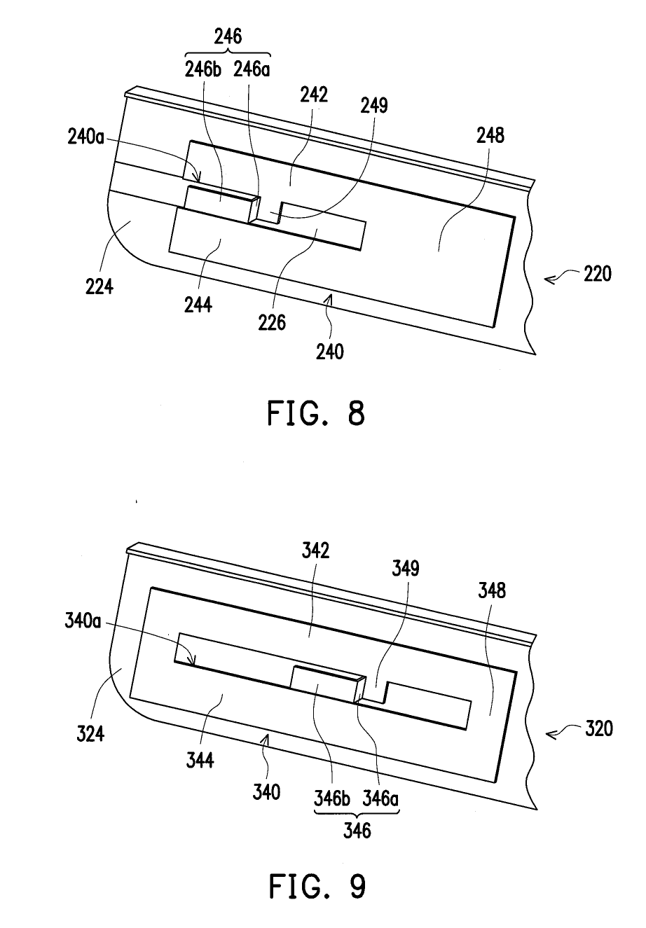

FIG. 8 is perspective diagram illustrating partial structure of an electronic device at the location of an antenna structure according to another embodiment of the invention. In the embodiment of FIG. 8, configurations and mode of actions of an antenna structure 240, a slot 240a, a first radiation portion 242, a second radiation portion 244, a third radiation portion 246, a first section 246a, a second section 246b, a grounding portion 248, and a connecting section 249 are similar to that of the antenna structure 140, the slot 140a, the first radiation portion 142, the second radiation portion 144, the third radiation portion 146, the first section 146a, the second section 146b, the grounding portion 148, and the connecting section 149 shown in FIG. 5, and thus are not to be repeated. Differences between the embodiment shown in FIG. 8 and the embodiment shown in FIG. 5 lie in that, the pivot assembly 220 has a metal casing 224 and a plastic member 226, the antenna structure 240 is disposed on the metal casing 224 and the plastic member 226 is engaged in the metal casing 224 and aligned to the slot 240a, so that the metal casing 224 forms a part of the antenna.

Other embodiments of the antenna structure of the invention, accompanied by drawings, are further described in below. FIG. 9 is perspective diagram illustrating partial structure of an electronic device at the location of an antenna structure according to another embodiment of the invention. In the embodiment shown in FIG. 9, configurations and mode of actions of a pivot assembly 320, a plastic casing 324, a first radiation portion 342, a second radiation portion 344, a third radiation portion 346, a first section 346a, a second section 346b, a grounding portion 348, and a connecting section 349 are similar to that of the pivot assembly 120, the plastic casing 124, the first radiation portion 142, the second radiation portion 144, the third radiation portion 146, the first section 146a, the second section 146b, the grounding portion 148, and the connecting section 149 shown in FIG. 5, and thus are not to be repeated herein. Differences between the embodiment shown in FIG. 9 and the embodiment shown in FIG. 5 lie in that, a slot 340a of the antenna structure 340 is a closed slot, and a length of the slot 340a, for example, equals one-half the wavelength of the first signal.

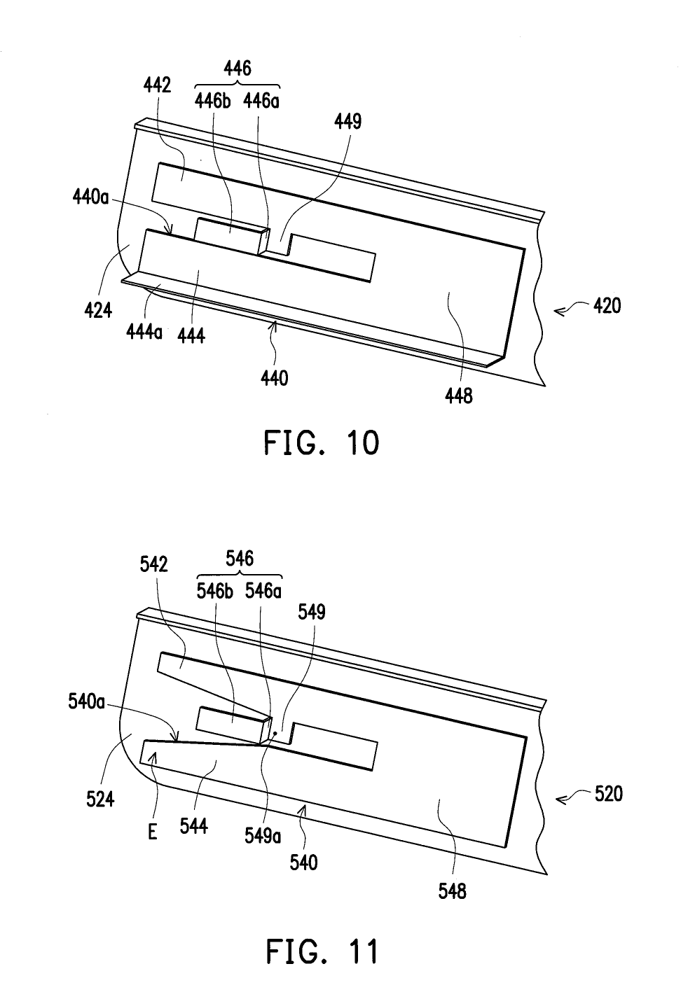

FIG. 10 is perspective diagram illustrating partial structure of an electronic device at the location of an antenna structure according to another embodiment of the invention. In the embodiment shown in FIG. 10, configurations and mode of actions of a pivot assembly 420, a plastic casing 424, a slot 440a, a first radiation portion 442, a third radiation portion 446, a first section 446a, a second section 446b, a grounding portion 448, and a connecting section 449 are similar to that of the pivot assembly 120, the casing 124, the slot 140a, the first radiation portion 142, the third radiation portion 146, the first section 146a, the second section 146b, the grounding portion 148, and the connecting section 149 shown in FIG. 5, and thus are not to be repeated herein. A difference between the embodiment shown in FIG. 10 and the embodiment shown in FIG. 5 lies in that, a second radiation portion 444 of the antenna structure 440 has a folded wall 444a, thereby capable of increasing an area of the second radiation portion 444 for enhancing signal transceving ability.

FIG. 11 is perspective diagram illustrating partial structure of an electronic device at the location of an antenna structure according to another embodiment of the invention. In the embodiment shown in FIG. 11, configurations and mode of actions of a pivot assembly 520, a plastic casing 524, a first radiation portion 542, a second radiation portion 544, a third radiation portion 546, a first section 546a, a second section 546b, a grounding portion 548, and a connecting section 549 are similar to that of the pivot assembly 120, the casing 124, the first radiation portion 142, the second radiation portion 144, the third radiation portion 146, the first section 146a, the second section 146b, the grounding portion 148, and the connecting section 149 shown in FIG. 5, and thus are not to be repeated herein. A difference between the embodiment shown in FIG. 11 and the embodiment shown in FIG. 5 lies in that, a width of the slot 540a gradually increases from the feed point 549a towards an open end E of the slot 540a, so as to increase a distances between the first radiation portion 542 and the second radiation portion 544 at the open end E, thereby capable of lowering an electric field coupling effect of the slot 540a at the open end E.

In summary, in the electronic device of the invention, the antenna structure, instead of being disposed in the second body, is disposed in the pivot assembly; and therefore, when the second body actuates in relative to the first body, the relative positions of the antenna structure and the first body do not change substantially following the movement of the second body, so that the antenna structure is prevented from being shielded by the metal casing of the first body, thus providing the antenna structure with stable signal transceving ability. In addition, the antenna structure of the invention forms the slot antenna with the slot between the first radiation portion and the second radiation portion, and forms the monopole antenna with the third radiation portion, so as to cover a larger antenna operating frequency band with the coordination between the slot antenna and the monopole antenna. Moreover, in invention, since the third radiation portion and the slot are not coplanar, the slot antenna and the monopole antenna do not interfere with each other and both have favorable signal transceving ability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a first body;
a pivot assembly, pivoted to the first body along a first axis;
a second body, pivoted to the pivot assembly along a second axis;
at least one antenna structure, disposed in the pivot assembly and having a first radiation portion, a second radiation portion and a third radiation portion, wherein the first radiation portion and the second radiation portion have a slot therebetween to form a slot antenna, the third radiation portion forms a monopole antenna and is aligned to the slot, and the third radiation portion and the slot are not coplanar.

2. The electronic device as recited in claim 1, wherein the second body is opened from or closed to the first body through a relative pivoting between the first body and the pivot assembly along the first axis.

3. The electronic device as recited in claim 1, wherein the first axis is perpendicular to the second axis.

4. The electronic device as recited in claim 1, wherein the pivot assembly has a metal shaft, the antenna structure has a grounding portion, and the grounding portion is connected to the metal shaft.

5. The electronic device as recited in claim 1, wherein a length of the slot is equal to one-fourth or one-half of a wavelength of a first signal, a length of the third radiation portion equals to one-fourth of a wavelength of a second signal.

6. The electronic device as recited in claim 5, wherein a frequency of the second signal is greater than a frequency of the first signal.

7. The electronic device as recited in claim 1, wherein the antenna structure has a connecting section, the connecting section is connected with the first radiation portion and located in the slot, the third radiation portion comprises a first section and a second section that are bent with each other, and the first section is connected between the connecting section and the second section.

8. The electronic device as recited in claim 1, further comprising a cable, wherein the cable comprises a signal line and a ground line, the connecting section has a feed point, the second radiation portion has a ground point, the signal line is connected to the feed point, and the ground line is connected to the ground point.

9. The electronic device as recited in claim 1, wherein the pivot assembly has a plastic casing, and the antenna structure is disposed on the plastic casing.

10. The electronic device as recited in claim 1, wherein the pivot assembly has a metal casing, and the antenna structure is disposed on the metal casing.

11. The electronic device as recited in claim 10, wherein the pivot assembly has a plastic member, and the plastic member is engaged in the metal casing and aligned to the slot.

12. The electronic device as recited in claim 1, wherein the second radiation portion has a folded wall.

13. The electronic device as recited in claim 1, wherein the slot has an open end, the antenna structure has a feed point in the slot, and a width of the slot gradually increases from the feed point towards the open end.

14. The electronic device as recited in claim 1, wherein the slot is a closed slot.
